(19) United States
(12) Patent Application Publication
(10) Pub. No.: US 2022/0369594 A1
(43) Pub. Date: Nov. 24, 2022

(54) Pet Bathing Assembly

(71) Applicant: Edgar Velasco, Santa Ana, CA (US)

(72) Inventor: Edgar Velasco, Santa Ana, CA (US)

(21) Appl. No.: 17/324,812

(22) Filed: May 19, 2021

(51) Int. Cl. A01K 13/00

(52) U.S. Cl. CPC A01K 13/001

(57) ABSTRACT

A pet bathing assembly for bathing a pet includes a box that includes a top portion which is hingedly coupled to a bottom portion. The top portion has a pair of hand openings each extending through the top portion to have a user's hands extended through the hand openings for washing the pet. A pair of gloves is each coupled to the top portion of the box to insertably receive a respective one of the user's hands. A shower head is coupled to the box to direct a fluid downwardly onto the pet to bathe the pet. A reservoir contains a bathing solution and a hose is fluidly attachable between the reservoir and the shower head to deliver the bathing solution to the shower head for bathing the pet.

### (b) CROSS-REFERENCE TO RELATED APPLICATIONS

### Not Applicable

### (c) STATEMENT REGARDING FEDERALLY SPONSORED RESEARCH OR DEVELOPMENT

### Not Applicable

### (d) THE NAMES OF THE PARTIES TO A JOINT RESEARCH AGREEMENT

### Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

### Not Applicable

### (f) STATEMENT REGARDING PRIOR DISCLOSURES BY THE INVENTOR OR JOINT INVENTOR

### Not Applicable

### (g) BACKGROUND OF THE INVENTION

### (1) Field of the Invention

The disclosure relates to bathing devices and more particularly pertains to a new bathing device for bathing a pet. The device includes a transparent box, a pair of gloves that are integrated into the box and a shower head that is integrated into the box. A reservoir is included that contains a bathing solution and a hose is fluidly coupled between the reservoir and the shower head. A pet can be positioned in the box for bathing and the pet can be scrubbed by inserting hands into the gloves.

### (2) Description of Related Art Including Information Disclosed Under 37 CFR 1.97 and 1.98

The prior art relates to bathing devices including a variety of bathing enclosures that have a plurality of orifices to facilitate a pet that is enclosed to be scrubbed with hands extended through the orifices. The prior art discloses a pet washing tub that includes gloves that are integrated into the pet washing tub for insertably receiving hands to scrub a pet in the pet washing tub. The prior art discloses a variety of pet washing tubs that each includes a plurality of orifices and a pair of gloves that are matable to respective orifices for scrubbing a pet in the pet washing tub.

### (h) BRIEF SUMMARY OF THE INVENTION

An embodiment of the disclosure meets the needs presented above by generally comprising a box that includes a top portion which is hingedly coupled to a bottom portion. The top portion has a pair of hand openings each extending through the top portion to have a user's hands extended through the hand openings for washing the pet. A pair of gloves is each coupled to the top portion of the box to insertably receive a respective one of the user's hands. A shower head is coupled to the box to direct a fluid downwardly onto the pet to bathe the pet. A reservoir contains a bathing solution and a hose is fluidly attachable between the reservoir and the shower head to deliver the bathing solution to the shower head for bathing the pet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a pet bathing assembly according to an embodiment of the disclosure.

FIG. 2 is a back view of a box of an embodiment of the disclosure.

FIG. 3 is a front view of a box of an embodiment of the disclosure.

FIG. 4 is a left side view of a box of an embodiment of the disclosure.

FIG. 5 is a right side view of a box of an embodiment of the disclosure.

FIG. 6 is a top view of an embodiment of the disclosure.

FIG. 7 is a bottom view of a box of an embodiment of the disclosure.

FIG. 8 is a front phantom view of a reservoir of an embodiment of the disclosure.

FIG. 9 is a perspective view of a stand of an embodiment of the disclosure.

FIG. 10 is a perspective in-use view of an embodiment of the disclosure.

### (j) DETAILED DESCRIPTION OF THE INVENTION

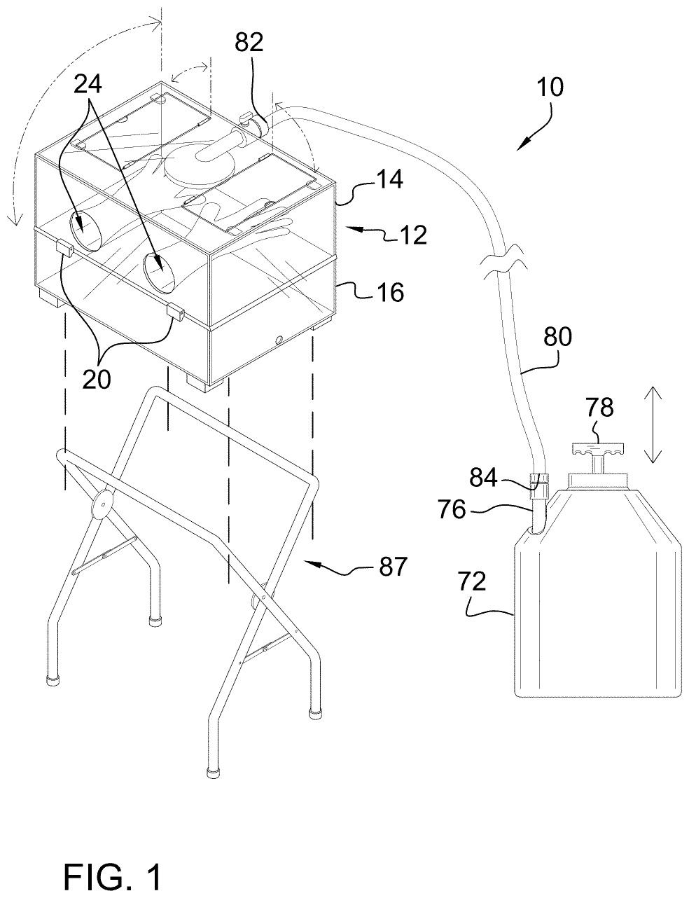

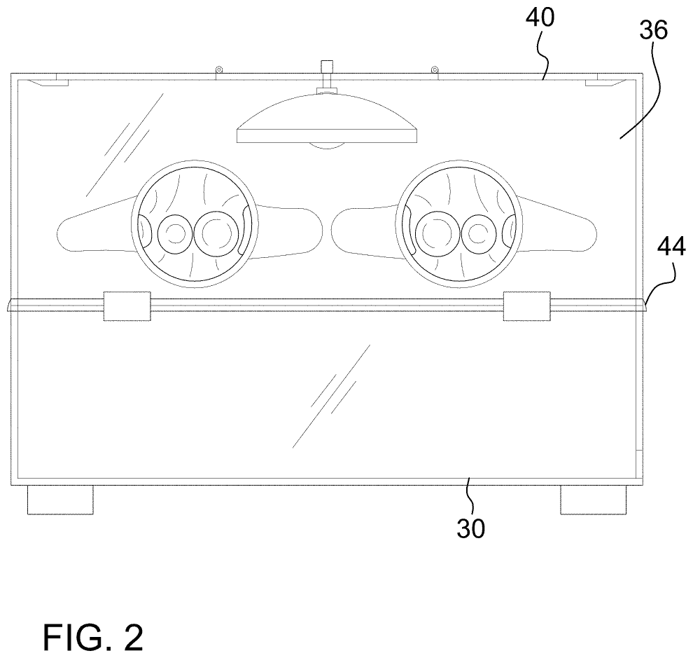

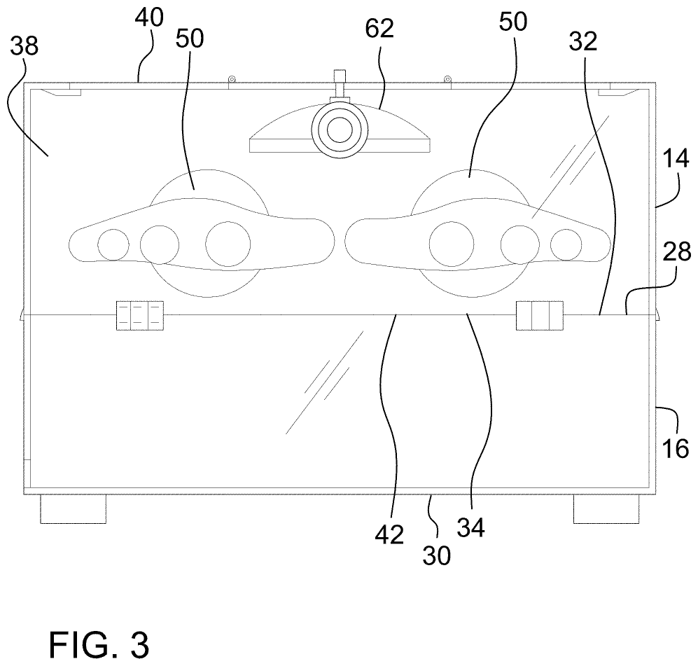

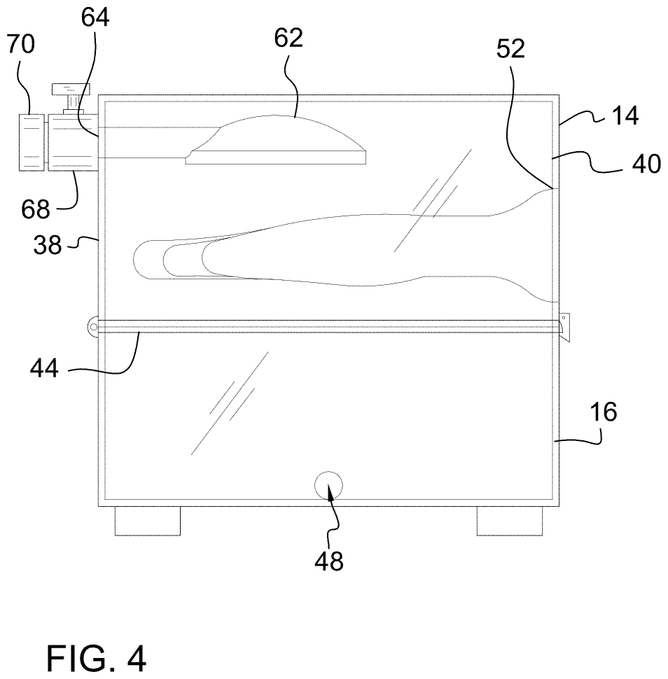

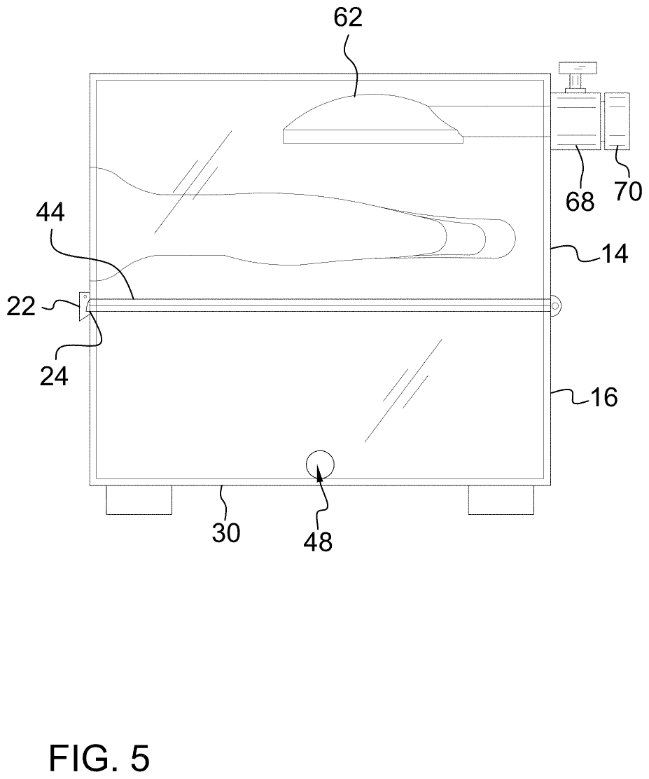

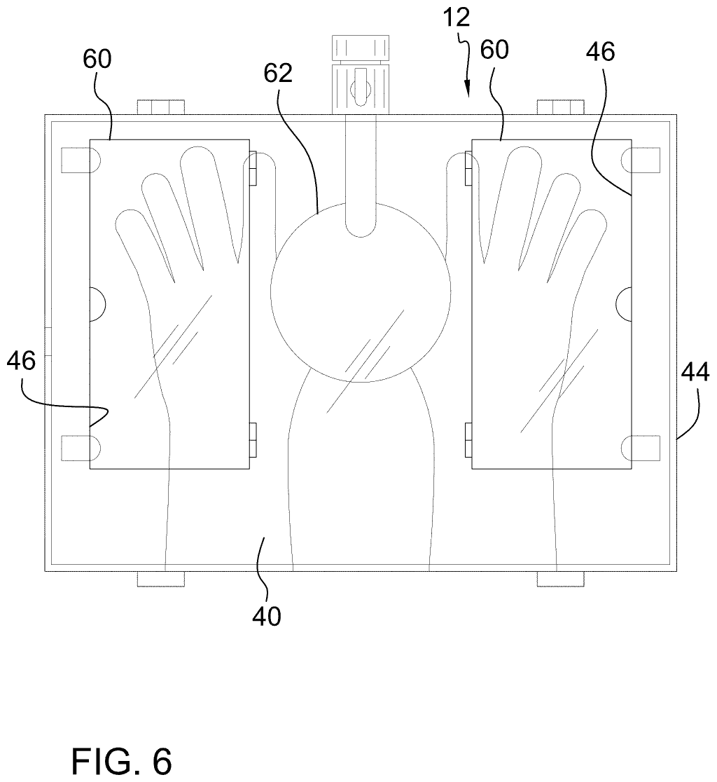

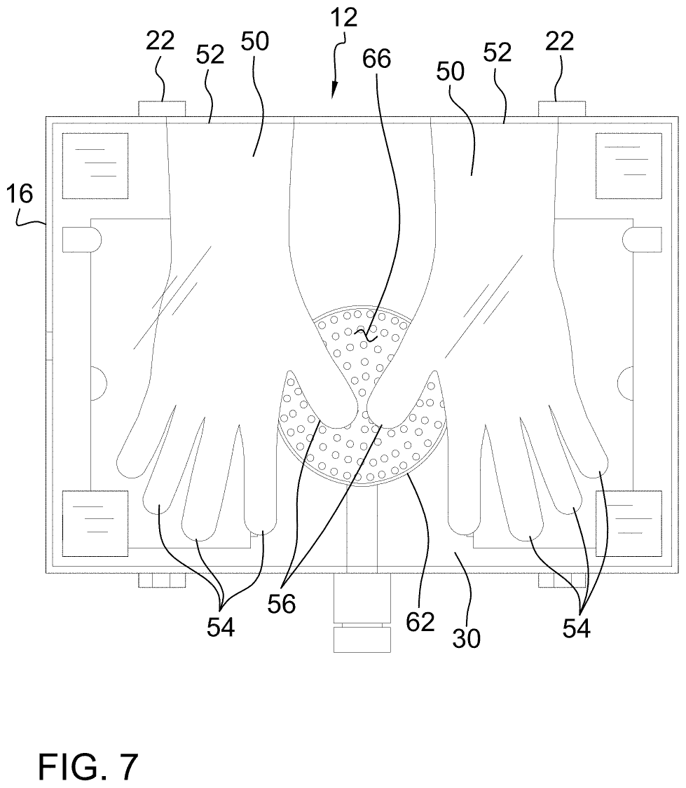

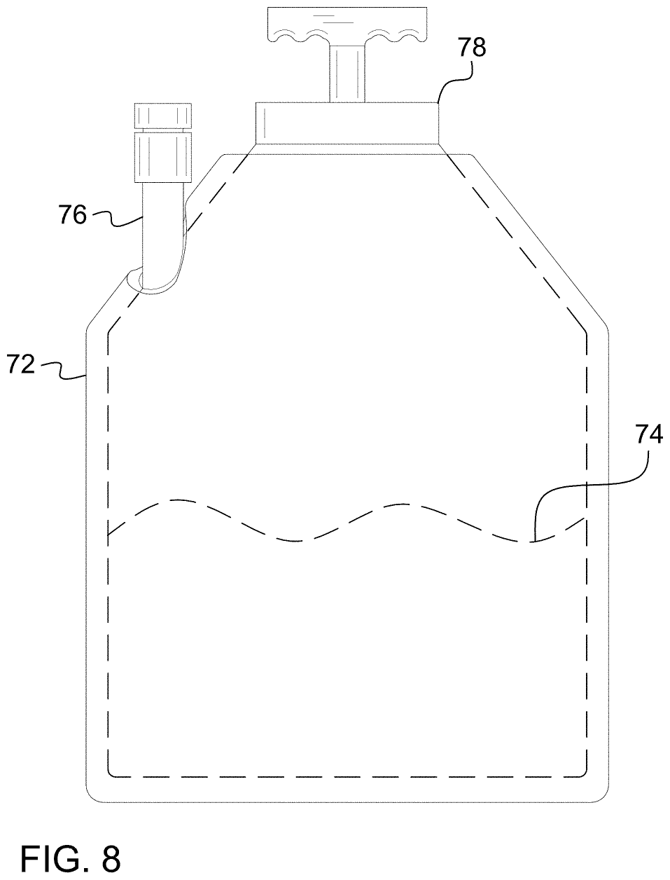

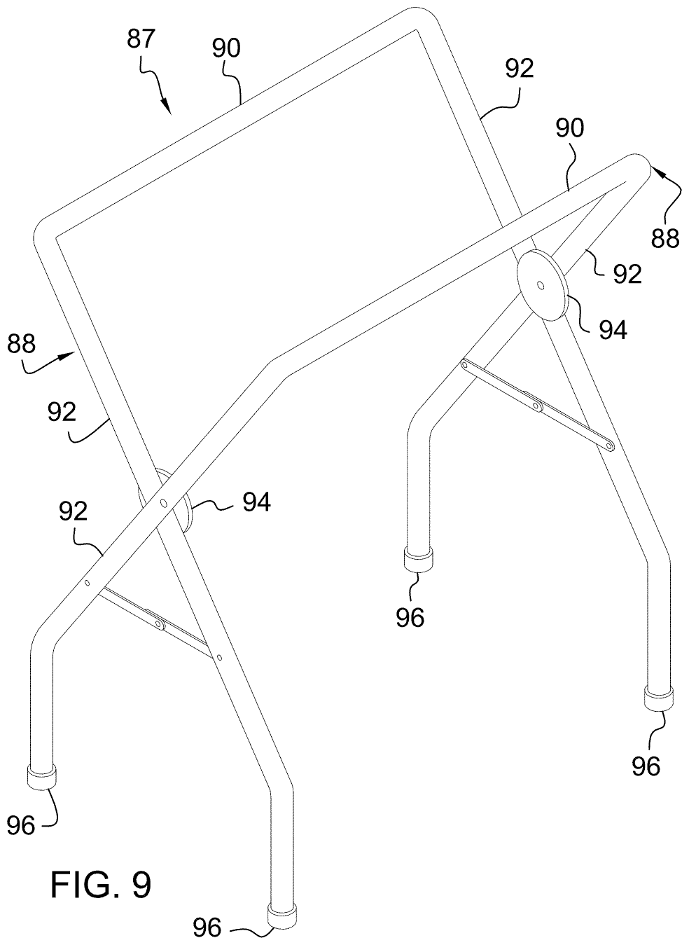

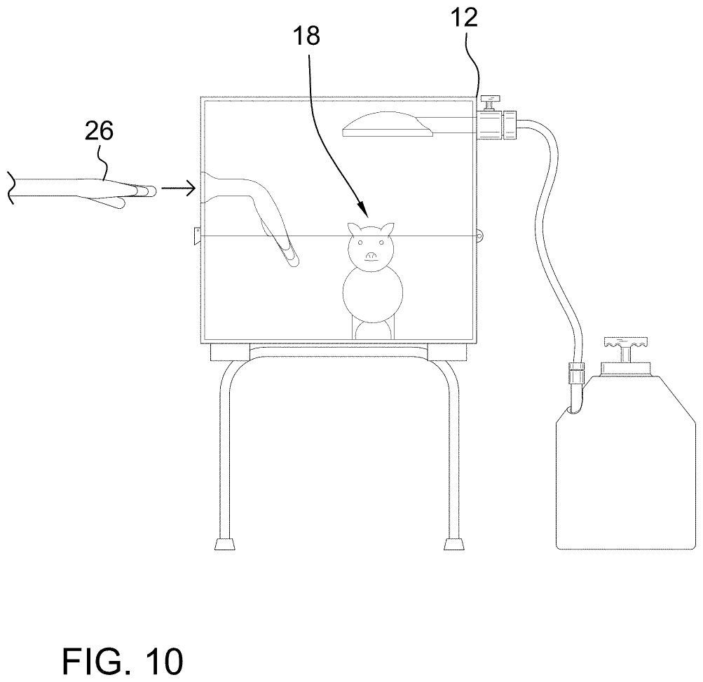

With reference now to the drawings, and in particular to FIGS. 1 through 10 thereof, a new bathing device embodying the principles and concepts of an embodiment of the disclosure and generally designated by the reference numeral 10 will be described.

As best illustrated in FIGS. 1 through 10, the pet bathing assembly 10 generally comprises a box 12 that includes a top portion 14 that is hingedly coupled to a bottom portion 16. The top portion 14 is positionable in an open position to facilitate a pet 18 to be positioned in the bottom portion 16. The pet 18 may be a house cat or other similarly sized, domesticated animal. The top portion 14 is positionable in a closed position to enclose the pet 18. Moreover, the box 12 is comprised of a translucent material to facilitate the pet 18 to be visible through the box 12. A pair of latches 20 may be disposed on the top portion 14 and each of the latches 20 releasably engages a respective engagement 22 on the bottom portion 16 to retain the top portion 14 in the closed position.

The top portion 14 has a pair of hand openings 24 each extending through the top portion 14. In this way a user's hands 26 can be extended through the hand openings 24 for washing the pet 18. The bottom portion 16 has a top edge 28 and a bottom wall 30, and the top edge 28 has a back side 32. The top portion 14 has a bottom edge 34, a rear wall 36, a front wall 38 and a top wall 40, and the bottom edge 34 has a rear side 42. The rear side 42 is hingedly coupled to the back side 32 and the top edge 28 rests on the bottom edge 34 when the top portion 14 is closed. A lip 44 may be coupled to the top portion 14 and the lip 44 may extend around the bottom edge 34 of the top portion 14.

Each of the hand openings 24 extends through the rear wall 36. The top wall 40 has a pair of holes 46 each extending through the top wall 40. Additionally, the holes 46 are positioned on opposite sides of the top wall 40 with respect to each other. The bottom portion 16 has a drain hole 48 extending into an interior of the bottom portion 16 to drain a liquid from the bottom portion 16.

A pair of gloves 50 is provided and each of the gloves 50 is coupled to the top portion 14 of the box 12. Each of the gloves 50 is aligned with a respective one of the hand openings 24 to insertably receive a respective one of the user's hands 26. Each of the gloves 50 includes a cuff 52, a plurality of fingers 54 and a thumb 56. The cuff 52 of each of the gloves 50 is coupled to an inside surface 58 of the rear wall 36 of the top portion 14 has the cuff 52 surrounding the respective hand opening. A pair of doors 60 is each hingedly coupled to the top wall 40 of the top portion 14 of the box 12. Each of the doors 60 is aligned with a respective one of the holes 46 in the top wall 40 and each of the doors 60 closes and opens the respective hole 46.

A shower head 62 is coupled to the box 12 and the shower head 62 extends through the top portion 14. In this way the shower head 62 is positioned inside of the box 12 when the top portion 14 is closed to direct a fluid downwardly onto the pet 18 to bathe the pet 18. The shower head 62 has a first end 64 that is positioned outside of the top portion 14. The shower head 62 has a foraminous spraying surface 66 that is directed toward the bottom wall 30 of the bottom portion 16 when the top portion 14 is closed.

A valve 68 is fluidly coupled to the shower head 62 and the valve 68 is positionable in an on position or an off position. The valve 68 is fluidly coupled to the first end 64 of the shower head 62 and the valve 68 has an inlet 70 is in fluid communication with the first end 64. The valve 68 facilitates a direction of flow between the inlet 70 and the first end 64 when the valve 68 is in the on position. Conversely, the valve 68 inhibits a direction of flow between the inlet 70 and the first end 64 when the valve 68 is in the off position.

A reservoir 72 is provided to contain a bathing solution 74 and the reservoir 72 has an outlet port 76. The bathing solution 74 may comprise water and a pet approved shampoo. A pump 78 is integrated into the reservoir 72 and the pump 78 is in fluid communication with an interior of the reservoir 72. The pump 78 pressurizes the interior of the reservoir 72 when the pump 78 is actuated to facilitate the bathing solution 74 to flow outwardly through the outlet port 76. The pump 78 may comprise a hand operated air pump or the like that can pressurize the interior of the reservoir 72 with air.

A hose 80 is fluidly attachable between the reservoir 72 and the shower head 62 to deliver the bathing solution 74 to the shower head 62 for bathing the pet 18. The hose 80 has a first end 82 and a second end 84. The first end 82 fluidly engages the outlet port 76 on the reservoir 72 to receive the bathing solution 74 from the reservoir 72. The second end 84 fluidly engages the inlet 70 of the valve 68 to deliver the bathing solution 74 to the valve 68.

A stand 87 is included that comprises a pair of leg sections 88 that are pivotally coupled together such that the stand 87 is positionable between a deployed position and a collapsed position. The box 12 is positionable on the stand 87 when the leg sections 88 are positioned in the deployed position. In this way the box 12 can be positioned at a convenient height for the user to extend their hands 26 through the hand openings 24. Each of the leg sections 88 includes a central member 90 extending between a pair of outward members 92. Each of the outward members 92 of the leg sections 88 is pivotally coupled to a respective outward member of the leg sections 88 at a pivot point 94 that is centrally positioned along a length of the outward members 92. Each of the outward members 92 has a distal end 96 with respect to the central member 90. The distal end 96 of each of the outward members 92 abuts a support surface has the central member 90 of each of the leg sections 88 is horizontally oriented when the stand 87 is positioned in the deployed position. The bottom wall 30 of the bottom section of the box 12 rests on the central member 90 of each of the leg sections 88 when the stand 87 is positioned in the deployed position.

In use, the box 12 is positioned on the stand 87, the top portion 14 is positioned in the open position, the pet 18 is positioned in the bottom portion 16 and the top portion 14 is positioned in the closed position. The hose 80 is fluidly coupled between the reservoir 72 and the valve 68 and the pump 78 is manipulated to pressurize the interior of the reservoir 72. The valve 68 is actuated into the on position and the user extends their hands 26 into the gloves 50. The water flows outwardly through the shower head 62 for bathing the pet 18. The user can scrub the pet 18 with the gloves 50 to thoroughly bathe the pet 18. The valve 68 is actuated into the off position, the top portion 14 of the box 12 is positioned in the open position and the pet 18 is removed from the box 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet bathing assembly for bathing a pet in an enclosure, said assembly comprising:
a box comprising a top portion being hingedly coupled to a bottom portion, said top portion being positionable in an open position wherein said box is configured to have a pet positioned in said bottom portion, said top portion being positionable in a closed position wherein said box is configured to enclose the pet, said box being comprised of a translucent material wherein said box is configured to facilitate the pet to be visible through said box, said top portion having a pair of hand openings each extending through said top portion wherein said hand openings are configured to have a user's hands extended through said hand openings for washing the pet;
a pair of gloves, each of said gloves being coupled to said top portion of said box, each of said gloves being aligned with a respective one of said hand openings wherein each of said gloves is configured to insertably receive a respective one of the user's hands;
a shower head being coupled to said box, said shower head extending through said top portion such that said shower head is positioned inside of said box when said top portion is closed wherein said shower head is configured to direct a fluid downwardly onto the pet to bathe the pet;
a valve being fluidly coupled to said shower head, said valve being positionable in an on position or an off position;
a reservoir being configured to contain a bathing solution;
a pump being integrated into said reservoir wherein said pump is configured to pump the bathing solution;
a hose being fluidly attachable between said reservoir and said shower head wherein said hose is configured to deliver the bathing solution to said shower head for bathing the pet; and
a stand comprising a pair of leg sections being pivotally coupled together such that said stand is positionable between a deployed position and a collapsed position, said box being positionable on said stand when said leg sections are positioned in said deployed position wherein said stand is configured to position said box at a convenient height for the user to extend their hands through said hand openings.

2. The assembly according to claim 1, wherein:
said bottom portion has a top edge and a bottom wall, said top edge having a back side, said top portion having a bottom edge, a rear wall, a front wall and a top wall, said bottom edge having a rear side, said rear side being hingedly coupled to said back side, said top edge resting on said bottom edge when said top portion is closed, each of said hand openings extending through said rear wall, said top wall having a pair of holes each extending through said top wall, said holes being positioned on opposite sides of said top wall with respect to each other, said bottom portion having a drain hole extending into an interior of said bottom portion wherein said drain hole is configured to drain a liquid from said bottom portion; and
each of said gloves includes a cuff, a plurality of fingers and a thumb, said cuff of each of said gloves being coupled to an inside surface of said rear wall of said top portion having said cuff surrounding said respective hand opening.

3. The assembly according to claim 2, wherein:
said shower head has a first end being positioned outside of said top portion, said shower head having a foraminous spraying surface being directed toward said bottom wall of said bottom portion when said top portion is closed; and
said valve is fluidly coupled to said first end of said shower head, said valve having an inlet being in fluid communication with said first end, said valve facilitating a direction of flow between said inlet and said first end when said valve is in said on position, said valve inhibiting a direction of flow between said inlet and said first end when said valve is in said off position.

4. The assembly according to claim 1, wherein:
said reservoir has an outlet port; and
said pump is in fluid communication with an interior of said reservoir, said pump pressurizing said interior of said reservoir when said pump is actuated wherein said pump is configured to facilitate the bathing solution to flow outwardly through said outlet port.

5. The assembly according to claim 4, wherein said hose has a first end and a second end, said first end fluidly engaging said outlet port on said reservoir wherein said hose is configured to receive the bathing solution from said reservoir, said second end fluidly engaging an inlet of said valve wherein said hose is configured to deliver the bathing solution to said valve.

6. The assembly according to claim 1, wherein each of said leg sections includes a central member extending between a pair of outward members, each of said outward members of said leg sections being pivotally coupled to a respective outward member of said leg sections at a pivot point being centrally positioned along a length of said outward members, each of said outward members having a distal end with respect to said central member, said distal end of each of said outward members abutting the support surface having said central member of each of said leg sections being horizontally oriented when said stand is positioned in said deployed position, a bottom wall of said bottom section of said box resting on said central member of each of said leg sections when said stand is positioned in said deployed position.

7. A pet bathing assembly for bathing a pet in an enclosure, said assembly comprising:
a box comprising a top portion being hingedly coupled to a bottom portion, said top portion being positionable in an open position wherein said box is configured to have a pet positioned in said bottom portion, said top portion being positionable in a closed position wherein said box is configured to enclose the pet, said box being comprised of a translucent material wherein said box is configured to facilitate the pet to be visible through said box, said top portion having a pair of hand openings each extending through said top portion wherein said hand openings are configured to have a user's hands extended through said hand openings for washing the pet, said bottom portion having a top edge and a bottom wall, said top edge having a back side, said top portion having a bottom edge, a rear wall, a front wall and a top wall, said bottom edge having a rear side, said rear side being hingedly coupled to said back side, said top edge resting on said bottom edge when said top portion is closed, each of said hand openings extending through said rear wall, said top wall having a pair of holes each extending through said top wall, said holes being positioned on opposite sides of said top wall with respect to each other, said bottom portion having a drain hole extending into an interior of said bottom portion wherein said drain hole is configured to drain a liquid from said bottom portion;
a pair of gloves, each of said gloves being coupled to said top portion of said box, each of said gloves being aligned with a respective one of said hand openings wherein each of said gloves is configured to insertably receive a respective one of the user's hands, each of said gloves including a cuff, a plurality of fingers and a thumb, said cuff of each of said gloves being coupled to an inside surface of said rear wall of said top portion having said cuff surrounding said respective hand opening;
a pair of doors, each of said doors being hingedly coupled to said top wall of said top portion of said box, each of said doors being aligned with a respective one of said holes in said top wall, each of said doors closing and opening said respective hole;
a shower head being coupled to said box, said shower head extending through said top portion such that said shower head is positioned inside of said box when said top portion is closed wherein said shower head is configured to direct a fluid downwardly onto the pet to bathe the pet, said shower head having a first end being positioned outside of said top portion, said shower head having a foraminous spraying surface being directed toward said bottom wall of said bottom portion when said top portion is closed;
a valve being fluidly coupled to said shower head, said valve being positionable in an on position or an off position, said valve being fluidly coupled to said first end of said shower head, said valve having an inlet being in fluid communication with said first end, said valve facilitating a direction of flow between said inlet and said first end when said valve is in said on position, said valve inhibiting a direction of flow between said inlet and said first end when said valve is in said off position;
a reservoir being configured to contain a bathing solution, said reservoir having an outlet port;
a pump being integrated into said reservoir, said pump being in fluid communication with an interior of said reservoir, said pump pressurizing said interior of said reservoir when said pump is actuated wherein said pump is configured to facilitate the bathing solution to flow outwardly through said outlet port;
a hose being fluidly attachable between said reservoir and said shower head wherein said hose is configured to deliver the bathing solution to said shower head for bathing the pet, said hose having a first end and a second end, said first end fluidly engaging said outlet port on said reservoir wherein said hose is configured to receive the bathing solution from said reservoir, said second end fluidly engaging said inlet of said valve wherein said hose is configured to deliver the bathing solution to said valve; and
a stand comprising a pair of leg sections being pivotally coupled together such that said stand is positionable between a deployed position and a collapsed position, said box being positionable on said stand when said leg sections are positioned in said deployed position wherein said stand is configured to position said box at a convenient height for the user to extend their hands through said hand openings, each of said leg sections including a central member extending between a pair of outward members, each of said outward members of said leg sections being pivotally coupled to a respective outward member of said leg sections at a pivot point being centrally positioned along a length of said outward members, each of said outward members having a distal end with respect to said central member, said distal end of each of said outward members abutting the support surface having said central member of each of said leg sections being horizontally oriented when said stand is positioned in said deployed position, said bottom wall of said bottom section of said box resting on said central member of each of said leg sections when said stand is positioned in said deployed position.
